(19) United States
(12) Patent Application Publication
(10) Pub. No.: US 2017/0295596 A1
(43) Pub. Date: Oct. 12, 2017

(54) HIGH-SPEED RANDOM ACCESS CHANNEL RESOURCE SETS

(71) Applicant: QUALCOMM Incorporated, San Diego, CA (US)

(72) Inventors: Wanshi Chen, San Diego, CA (US); Peter Gaal, San Diego, CA (US)

(21) Appl. No.: 15/432,587

(22) Filed: Feb. 14, 2017

Related U.S. Application Data
(60) Provisional application No. 62/321,193, filed on Apr. 11, 2016.

(51) Int. Cl. H04W 74/08; H04L 27/26

(52) U.S. Cl. CPC H04W 74/0833; H04L 27/2613

(57) ABSTRACT

Methods, systems, and devices for wireless communication are described. A base station may differentiate, determine, configure, employ and/or allocate a first physical random access channel (PRACH) resource set and a second PRACH resource set, the first PRACH resource set to be used by user equipments (UEs) experiencing a higher Doppler condition than UEs using the second PRACH resource set. The base station may transmit an indication of the first PRACH resource set and the second PRACH resource set to the UE. The UE may receive the indication and determine the current Doppler conditions. Based on the Doppler conditions, the UE may select the first or second PRACH resource set to use for transmission of a random access message to the base station.

### CROSS REFERENCES

The present Application for Patent claims priority to U.S. Provisional Patent Application No. 62/321,193 by Chen, et al., entitled “High-Speed Random Access Channel Resource Sets,” filed Apr. 11, 2016, assigned to the assignee hereof.

### BACKGROUND

### Field of the Disclosure

The following relates generally to wireless communication, and more specifically to high-speed random access channel (RACH) resource sets.

### Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems. A wireless multiple-access communications system may include a number of base stations, each simultaneously supporting communication for multiple communication devices, which may each be referred to as a user equipment (UE).

In some wireless communication systems, a UE may initiate random access by transmitting random access preambles in a physical random access channel (PRACH). The preambles may be generated using various cyclic shifts. In some cases, the cyclic shifts available for use may be inappropriate or inadequate for high-speed movement of a UE. For example, random access preambles may experience uplink Doppler shift due to movement of a UE. A Doppler shift may impact the ability of a base station to process the random access preamble. Improved methods of random access are desired.

### SUMMARY

A base station may determine a first physical random access channel (PRACH) resource set to be used by one or more user equipments (UEs) when a UE experiences a high Doppler condition (e.g., a UE may be moving at a high speed) and a second PRACH resource set to be used by one or more UEs when a UE experiences a low or lower Doppler condition (e.g., a UE may be moving at a regular or low speed). The base station may transmit an indication to the UE that the first PRACH resource set and the second PRACH resource set are available. The UE may receive the indication and determine the current Doppler conditions. Based on the Doppler conditions, the UE may select the first or second PRACH resource set to use for transmission of a random access message to the base station. Alternatively, the UE may select either the first or the second PRACH resource set based on an indication received from the base station.

A method of wireless communication is described. The method may include differentiating between a first PRACH resource set and a second PRACH resource set, the first PRACH resource set to be used by UEs experiencing a higher Doppler condition than UEs using the second PRACH resource set and transmitting an indication that the first PRACH resource set and the second PRACH resource set are supported.

An apparatus for wireless communication is described. The apparatus may include means for differentiating between a first PRACH resource set and a second PRACH resource set, the first PRACH resource set to be used by UEs experiencing a higher Doppler condition than UEs using the second PRACH resource set. The apparatus may include means for transmitting an indication that the first PRACH resource set and the second PRACH resource set are supported.

A further apparatus is described. The apparatus may include a processor, memory in electronic communication with the processor, and instructions stored in the memory. The instructions may be operable to cause the processor to differentiate between a first PRACH resource set and a second PRACH resource set, the first PRACH resource set to be used by UEs experiencing a higher Doppler condition than UEs using the second PRACH resource set. The instructions may be operable to cause the processor to transmit an indication that the first PRACH resource set and the second PRACH resource set are supported.

A non-transitory computer readable medium for wireless communication is described. The non-transitory computer-readable medium may include one or more instructions to cause a processor to differentiate between a first PRACH resource set and a second PRACH resource set, the first PRACH resource set to be used by UEs experiencing a higher Doppler condition than UEs using the second PRACH resource set. The non-transitory computer-readable medium may include one or more instructions to cause a processor to transmit an indication that the first PRACH resource set and the second PRACH resource set are supported.

In some examples, the first PRACH resource set is associated with a first cyclic shift that is detectable at a first range of speeds and the second PRACH resource set is associated with a second cyclic shift that is detectable at a second range of speeds slower than the first range of speeds. Some examples of the method, apparatus, or non-transitory computer-readable medium described above may further include processes, features, means, or instructions for determining that the first PRACH resource set is to be used by UEs experiencing a Doppler condition that satisfies a threshold and the second PRACH resource set is to be used by UEs experiencing a Doppler condition that is less than the threshold.

Some examples of the method, apparatus, or non-transitory computer-readable medium described above may further include processes, features, means, or instructions for receiving a random access message from a UE using one of the first PRACH resource set or the second PRACH resource set in accordance with the Doppler condition experienced by the UE. In some examples of the method, apparatus, or non-transitory computer-readable medium described above, differentiating between the first PRACH resource set and the second PRACH resource set comprises: using frequency-division multiplexing (FDM) to separate the first PRACH resource set and the second PRACH resource set.

In some examples of the method, apparatus, or non-transitory computer-readable medium described above, using FDM comprises: separating the first PRACH resource set from the second PRACH resource set using at least one of different frequency ranges, subbands or component carriers (CCs). In some examples of the method, apparatus, or non-transitory computer-readable medium described above, differentiating between the first PRACH resource set and the second PRACH resource set comprises: using time-division multiplexing (TDM) to separate the first PRACH resource set and the second PRACH resource set.

In some examples of the method, apparatus, or non-transitory computer-readable medium described above, using TDM comprises: separating the first PRACH resource set from the second PRACH resources set using different subframes or different portions of a subframe. In some examples of the method, apparatus, or non-transitory computer-readable medium described above, differentiating between the first PRACH resource set and the second PRACH resource set comprises: using a first repetition level associated with the first PRACH resource set and a second repetition level associated with the second PRACH resource set.

In some examples of the method, apparatus, or non-transitory computer-readable medium described above, transmitting the indication comprises: including the indication as part of a system information block (SIB) transmission. Some examples of the method, apparatus, or non-transitory computer-readable medium described above may further include processes, features, means, or one or more instructions for transmitting to a UE a PRACH association indicator indicating to the UE one or more of the first PRACH resource set or the second PRACH resource set to be used by the UE.

In some examples of the method, apparatus, or non-transitory computer-readable medium described above, the PRACH association indicator indicates that the UE is to associate with the first PRACH resource set only. In some examples of the method, apparatus, or non-transitory computer-readable medium described above, the PRACH association indicator indicates that the UE is to associate with both the first PRACH resource set and the second PRACH resource set.

In some examples of the method, apparatus, or non-transitory computer-readable medium described above, the PRACH association indicator indicates that the UE is to determine, based on a Doppler condition experienced by the UE, whether to associate with the first PRACH resource set or the second PRACH resource set. In some examples of the method, apparatus, or non-transitory computer-readable medium described above, the PRACH association indicator indicates whether the UE may select between the first PRACH resource set and the second PRACH resource set.

Some examples of the method, apparatus, or non-transitory computer-readable medium described above may further include processes, features, means, or one or more instructions for transmitting a threshold indication to a UE. Some examples of the method, apparatus, or non-transitory computer-readable medium described above may further include processes, features, means, or instructions for transmitting to the UE a PRACH association indicator indicating to the UE that the UE is to determine, based on a Doppler condition experienced by the UE and the threshold indicated by the threshold indication, whether to associate with the first PRACH resource set or the second PRACH resource set.

Some examples of the method, apparatus, or non-transitory computer-readable medium described above may further include processes, features, means, or one or more instructions for receiving a random access message from a UE using one of the first PRACH resource set or the second PRACH resource set in accordance with a Doppler condition experienced by the UE. Some examples of the method, apparatus, or non-transitory computer-readable medium described above may further include processes, features, means, or instructions for selecting a reference signal (RS) density for at least one of physical downlink shared channel (PDSCH) or physical uplink shared channel (PUSCH) transmission based on whether the random access message was received on the first PRACH resource set or the second PRACH resource set.

Some examples of the method, apparatus, or non-transitory computer-readable medium described above may further include processes, features, means, or one or more instructions for receiving a random access message from a UE using one of the first PRACH resource set or the second PRACH resource set in accordance with a Doppler condition experienced by the UE. Some examples of the method, apparatus, or non-transitory computer-readable medium described above may further include processes, features, means, or instructions for selecting at least one of a resource allocation, a hopping option, a timing advance, a power control, or a random access message response time based on whether the random access message was received on the first PRACH resource set or the second PRACH resource set.

A method of wireless communication is described. The method may include receiving, at a UE, an indication that a first PRACH and a second PRACH resource set are supported, wherein the first PRACH resource set is to be used by UEs experiencing a higher Doppler condition than UEs using the second PRACH resource set. The method may include transmitting, by the UE, a random access message using one of the first PRACH resource set or the second PRACH resource set in accordance with a Doppler condition experienced by the UE.

An apparatus for wireless communication is described. The apparatus may include means for receiving, at a UE, an indication that a first PRACH and a second PRACH resource set are supported, wherein the first PRACH resource set is to be used by UEs experiencing a higher Doppler condition than UEs using the second PRACH resource set. The apparatus may include means for transmitting, by the UE, a random access message using one of the first PRACH resource set or the second PRACH resource set in accordance with a Doppler condition experienced by the UE.

A further apparatus is described. The apparatus may include a processor, memory in electronic communication with the processor, and one or more instructions stored in the memory. The instructions may be operable to cause the processor to receive, at a UE, an indication that a first PRACH and a second PRACH resource set are supported, wherein the first PRACH resource set is to be used by UEs experiencing a higher Doppler condition than UEs using the second PRACH resource set. The instructions may be operable to cause the UE to transmit a random access message using one of the first PRACH resource set or the second PRACH resource set in accordance with a Doppler condition experienced by the UE.

A non-transitory computer readable medium for wireless communication is described. The non-transitory computer-readable medium may include one or more instructions to cause a processor to receive, at a UE, an indication that a first PRACH and a second PRACH resource set are supported, wherein the first PRACH resource set is to be used by UEs experiencing a higher Doppler condition than UEs using the second PRACH resource set. The non-transitory computer-readable medium may include one or more instructions to cause the UE to transmit a random access message using one of the first PRACH resource set or the second PRACH resource set in accordance with an experienced Doppler condition.

In some examples of the method, apparatus, or non-transitory computer-readable medium described above, transmitting the random access message comprises: transmitting the random access message using one or more frequency ranges, subbands or CCs that are associated with one of the first PRACH resource set or the second PRACH resource set. In some examples of the method, apparatus, or non-transitory computer-readable medium described above, transmitting the random access message comprises: transmitting the random access message using one or more subframes or portions of a subframe that are associated with one of the first PRACH resource set or the second PRACH resource set.

In some examples of the method, apparatus, or non-transitory computer-readable medium described above, transmitting the random access message comprises: transmitting the random access message using a repetition level associated with one of the first PRACH resource set or the second PRACH resource set. In some examples of the method, apparatus, or non-transitory computer-readable medium described above, receiving the indication comprises: receiving the indication as part of a SIB transmission.

Some examples of the method, apparatus, or non-transitory computer-readable medium described above may further include processes, features, means, or one or more instructions for receiving a PRACH association indicator indicating one or more of the first PRACH resource set or the second PRACH resource set to be used. In some examples of the method, apparatus, or non-transitory computer-readable medium described above, the PRACH association indicator indicates that the UE is to associate with the first PRACH resource set only.

In some examples of the method, apparatus, or non-transitory computer-readable medium described above, the PRACH association indicator indicates that the UE is to associate with both the first PRACH resource set and the second PRACH resource set. In some examples of the method, apparatus, or non-transitory computer-readable medium described above, the PRACH association indicator indicates that the UE is to determine, based on the experienced Doppler condition, whether to associate with the first PRACH resource set or the second PRACH resource set.

In some examples of the method, apparatus, or non-transitory computer-readable medium described above, the PRACH association indicator indicates whether the UE may select between the first PRACH resource set and the second PRACH resource set. Some examples of the method, apparatus, or non-transitory computer-readable medium described above may further include processes, features, means, or instructions for receiving a threshold indication. Some examples of the method, apparatus, or non-transitory computer-readable medium described above may further include processes, features, means, or instructions for receiving a PRACH association indicator indicating to the UE that the UE is to determine, based on the experienced Doppler condition and the threshold indicated by the threshold indication, whether to associate with the first PRACH resource set or the second PRACH resource set.

Some examples of the method, apparatus, or non-transitory computer-readable medium described above may further include processes, features, means, or one or more instructions for receiving at least one of PDSCH or PUSCH configuration having a RS density based on whether the random access message was transmitted on the first PRACH resource set or the second PRACH resource set. In some examples, the first PRACH resource set is associated with a first cyclic shift that is detectable at a first range of speeds and the second PRACH resource set is associated with a second cyclic shift that is detectable at a second range of speeds slower than the first range of speeds.

Some examples of the method, apparatus, or non-transitory computer-readable medium described above may further include processes, features, means, or one or more instructions for receiving at least one of a resource allocation, a hopping option, a timing advance, or a power control configuration based on whether the random access message was received on the first PRACH resource set or the second PRACH resource set.

Some examples of the method, apparatus, or non-transitory computer-readable medium described above may further include processes, features, means, or one or more instructions for communicating, using at least one of a resource allocation, a hopping option, a timing advance, or a power control configuration based on whether the random access message was received on the first PRACH resource set or the second PRACH resource set.

### BRIEF DESCRIPTION OF THE DRAWINGS

FIG. 1 illustrates an example of a wireless communications system that supports high-speed RACH resource sets in accordance with aspects of the present disclosure.

FIG. 2 illustrates an example of a wireless communications environment that supports high-speed RACH resource sets in accordance with aspects of the present disclosure.

FIG. 3 illustrates an example of a process flow in a system that supports high-speed RACH resource sets in accordance with aspects of the present disclosure.

FIGS. 4 through 6 show block diagrams of a wireless device that supports high-speed RACH resource sets in accordance with aspects of the present disclosure.

FIG. 7 illustrates a block diagram of a system including a base station that supports high-speed RACH resource sets in accordance with aspects of the present disclosure.

FIGS. 8 through 10 show block diagrams of a wireless device that supports high-speed RACH resource sets in accordance with aspects of the present disclosure.

FIG. 11 illustrates a block diagram of a system including a UE that supports high-speed RACH resource sets in accordance with aspects of the present disclosure.

FIGS. 12 through 16 illustrate methods for high-speed RACH resource sets in accordance with aspects of the present disclosure.

### DETAILED DESCRIPTION

A wireless system may utilize different uplink resources for random access procedures based on Doppler conditions. For example, the communications resources a user equipment (UE) uses for physical random access channel (PRACH) may vary depending on the Doppler conditions experienced by the UE. The UE may, for example, at the behest of a base station, use a first resource set for PRACH transmissions when Doppler conditions satisfy or exceed a threshold and use a second resource set when Doppler conditions do not satisfy or are less than the threshold. In another example, the UE may use the first PRACH resource set when the UE is experiencing higher Doppler conditions relative to UEs using the second PRACH resource set. Random access preambles sent in the PRACH using the first resource set may be generated using cyclic shifts that are detectable by the base station when the Doppler condition satisfies or exceeds the first threshold. Random access preambles sent in the PRACH using the second resource set may be generated using cyclic shifts that are detectable when the Doppler condition does not satisfy or is less than the threshold, but not when the Doppler condition satisfies or exceeds the threshold. In some cases, the first and second resource sets may be associated with different sets of restricted cyclic shifts. For example, the first resource set may be associated with a set of cyclic shifts that are available for use with high speed cells that support Doppler offset of, for example, ±2.5 kHz.

In some cases, a different number of cyclic shifts may be used for random access preambles conveyed by the first and second resource sets (e.g., a random access preamble sent using the first resource set may include only the root sequence and may be exclusive of cyclic shifts). The first and second resource sets may be differentiated in time (e.g., via time division multiplexing (TDM)) and/or in frequency (e.g., via frequency division multiplexing (FDM)). For example, the resource sets may be sent in different subframes, or using different subbands or component carriers (CCs). The UE may determine which resources to use autonomously, or based on information from the base station (e.g., information conveyed by a system information block (SIB)).

Aspects of this disclosure introduced above are described below in the context of a wireless communications system. Specific examples are described for Doppler-dependent resource selection in random access procedures. These and other aspects of the disclosure are further illustrated by and described with reference to apparatus diagrams, system diagrams, and flowcharts.

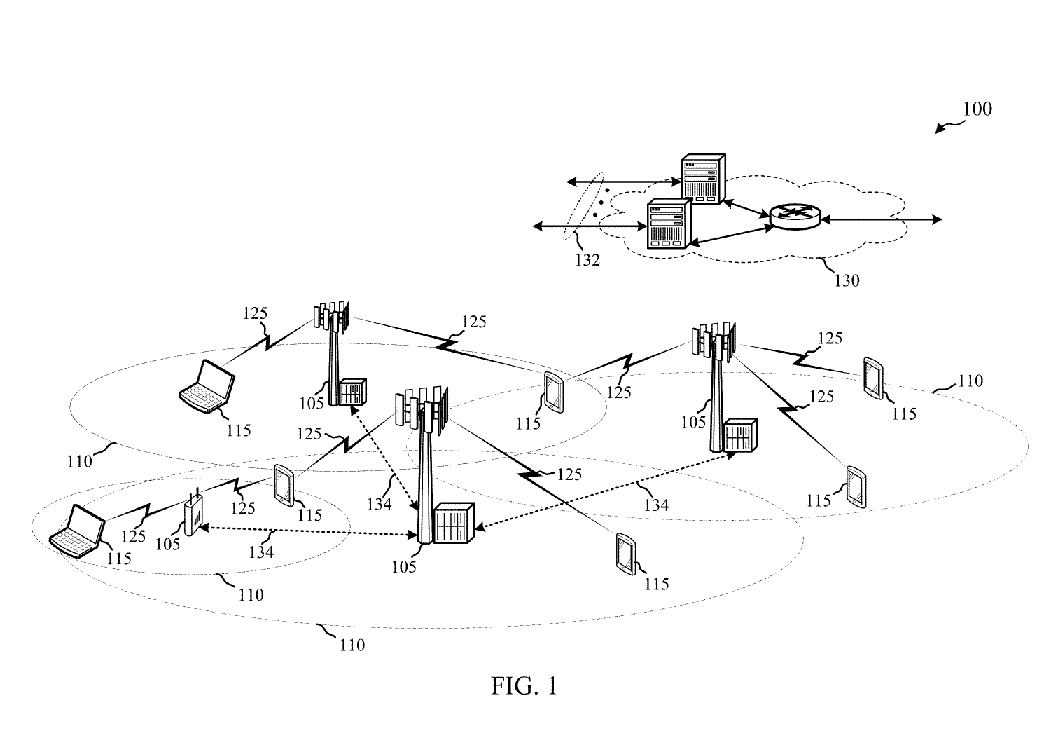

FIG. 1 illustrates an example of a wireless communications system 100 in accordance with aspects of the present disclosure. The wireless communications system 100 includes base stations 105, UEs 115, and a core network 130. In some examples, the wireless communications system 100 may be a Long Term Evolution (LTE)/LTE-Advanced (LTE-A) network. Wireless devices within wireless communications system 100 may use different resources for random access procedures when experiencing different levels of Doppler conditions.

Base stations 105 may wirelessly communicate with UEs 115 (e.g., using various radio access technologies (RATs) or wireless technologies) via one or more base station antennas. Each base station 105 may provide communication coverage for a respective geographic coverage area 110. Each base station 105 may provide communication coverage for a macro cell, a small cell, or other types of cell. The term “cell” is a 3rd Generation Partnership Project “3GPP” term that can be used to describe a base station, a carrier or component carrier associated with a base station, or a coverage area (e.g., sector, etc.) of a carrier or base station, depending on context. Communication links 125 shown in wireless communications system 100 may include uplink (UL) transmissions from a UE 115 to a base station 105, or downlink (DL) transmissions, from a base station 105 to a UE 115. UEs 115 may be dispersed throughout the wireless communications system 100, and each UE 115 may be stationary or mobile. A UE 115 may also be referred to as a mobile station, a subscriber station, a remote unit, a wireless device, an access terminal (AT), a handset, a user agent, a client, wireless communication UE apparatus, or like terminology. A UE 115 may also be a cellular phone, a wireless modem, a handheld device, a personal computer, a tablet, a personal electronic device, an machine type communication (MTC) device, etc.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller (not shown). In some examples, base stations 105 may be macro cells, small cells, hot spots, or the like. A base station 105 may also be referred to as an access point (“AP”), a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

After the UE 115 decodes System Information Block Type 2 (SIB2), it may transmit a random access channel (RACH) preamble to a base station 105. This may be known as RACH message 1. The RACH preamble may be randomly selected from a set of 64 predetermined sequences. This may enable the base station 105 to distinguish between multiple UEs 115 trying to access the system simultaneously. The base station 105 may respond with a random access response (RAR), or RACH message 2, that provides an UL resource grant, a timing advance and a temporary cell radio network temporary identity (C-RNTI). The UE 115 may then transmit a radio resource control (RRC) connection request, or RACH message 3, along with a temporary mobile subscriber identity (TMSI) (e.g., if the UE 115 has previously been connected to the same wireless network) or a random identifier. The RRC connection request may also indicate the reason the UE 115 is connecting to the network (e.g., emergency, signaling, data exchange, etc.). The base station 105 may respond to the connection request with a contention resolution message, or RACH message 4, addressed to the UE 115, which may provide a new C-RNTI. If the UE 115 receives a contention resolution message with the correct identification (ID), it may proceed with RRC setup. If the UE 115 does not receive a contention resolution message (e.g., if there is a conflict with another UE 115) it may repeat the RACH process by transmitting a new RACH preamble.

A UE 115 that intends to establish communications with a base station 105 may participate in a random access procedure with the base station 105, aspects of which are described herein. The UE 115 may synchronize with the base station 105 and then send a random access message to the base station that conveys information about upcoming communications from UE 115. The random access message may include a random access preamble, which may be conveyed via PRACH and may be divided into a cyclic prefix, a sequence, and a guard time. A base station 105 may monitor for the random access message during a window of time, which may be referred to as the observation window. A random access message may be transmitted with a number of cyclic shifts to increase the likelihood that the random access message arrives at the base station 105 during the observation window.

In some cases, a UE 115 may be travelling at a velocity high enough that communications between the UE 115 and a base station 105 experience various Doppler effects or conditions. In some cases, the Doppler effect may be significant enough that a base station 105 is unable to detect or receive the communications in question. For example, a random access preamble conveyed by PRACH may experience Doppler shifting to the extent that a base station 105 is unable to detect the preamble. For example, a cell capable of supporting high speed UEs 115 may have a PRACH cyclic shift restriction set that has a theoretical limitation of Doppler offset within ±1.5×1.25 KHz=±1.875 KHz. But a UE 115 travelling at 350 km/hr with a carrier frequency of 3.5 GHz may experience a Doppler offset of 2.269 KHz, which is outside the supported range of the cyclic shift restriction set.

Thus, according to the techniques described herein, a UE 115 may modify random access resources and processing (e.g., preamble generation) to compensate for or overcome Doppler conditions that exceed a certain threshold (e.g., the UE 115 may consider high-Doppler-specific random response and subsequent procedures). For example, a UE 115 may use different communication resource sets for PRACH transmission in different Doppler conditions. A UE 115 may use a first resource set for high Doppler conditions and a second resource set for low or lower Doppler conditions. That is, a first resource set may be reserved or allocated for use by UEs experiencing high Doppler conditions and a second resource set may be reserved or allocated for use by UEs experiencing comparatively low or lower Doppler conditions. In some cases, the preamble cyclic shifts are different for the first and second resource sets. In some cases, a different number of cyclic shifts are used for the first and second resource sets. In some cases, there may be a tradeoff between PRACH capacity and PRACH resolution for different cyclic shifts. Therefore, according to the techniques described herein, a UE 115 may selectively decide when to use enhanced cyclic shifts (e.g., in high-Doppler conditions).

In some cases, wireless communications system 100 may utilize enhanced component carriers (eCCs). An eCC may be characterized by one or more features including: wider bandwidth, shorter symbol duration, shorter transmission time interval (TTI), and modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide bandwidth may include one or more segments that may be utilized by UEs 115 that are not capable of monitoring the whole bandwidth or prefer to use a limited bandwidth (e.g., to conserve power).

In some cases, an eCC may use a different symbol duration than other component carriers (CCs), which may include use of a reduced symbol duration as compared with symbol durations of the other CCs. A shorter symbol duration is associated with increased subcarrier spacing. A device, such as a UE 115 or base station 105, using eCCs may transmit wideband signals (e.g., 20, 40, 60, 80 Mhz, etc.) at reduced symbol durations (e.g., 16.67 microseconds). A TTI in eCC may include one or multiple symbols. In some cases, the TTI duration (that is, the number of symbols in a TTI) may be variable.

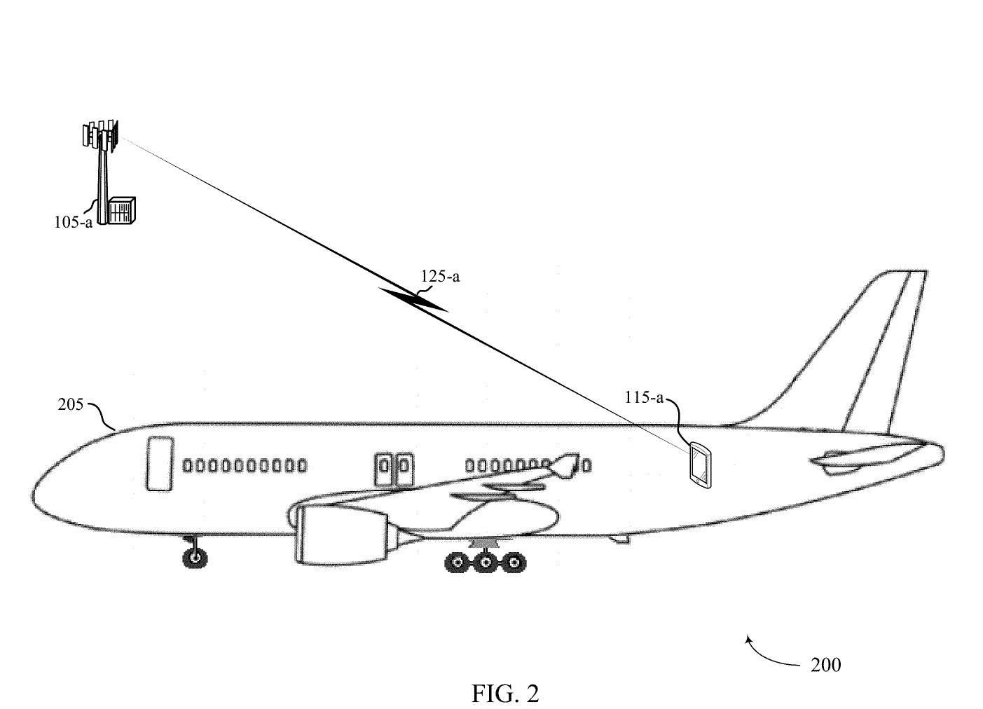

FIG. 2 illustrates an example of a wireless communications system 200 that supports high-speed RACH resource sets in accordance with aspects of the present disclosure. Wireless communications system 200 may include UE 115-a and base station 105-a, which may be examples of a UE 115 or a base station 105 described above with reference to FIG. 1. Base station 105-a may communicate with UE 115-a via communication link 125-a when UE 115-a is within coverage area of base station 105-a as generally described above with reference to FIG. 1. UE 115-a may be travelling at a high speed (e.g., 350 km/hr). For example, UE 115-a may be located on airplane 205, or located on another type of high-speed vehicle such as a car or a train etc. While moving at a high velocity, UE 115-a may initiate random access procedures such as described with reference to FIG. 1. The terms high velocity and high speed, or equivalents thereof, may refer to velocities above a certain threshold (e.g., above 350 km/hr), velocities at which base station 105-a is unable to successfully detect or receive unenhanced PRACH, or velocities at which a Doppler condition satisfies or exceeds a predetermined threshold (e.g., velocities at which a Doppler shift is outside of the range that can be properly handled by an existing cyclic shift restriction set).

UE 115-a may use different resources for PRACH based on the speed of UE 115-a, and different cyclic shifts may be allocated and/or used for the different resources. For example, UE 115-a may use a first set of resources for enhanced PRACH (e.g., PRACH conveying random access preambles that are detectable in high-speed scenarios) and use a second set of resources for unenhanced PRACH (e.g., PRACH conveying random access preambles that are undetectable in high-speed scenarios). A resource set allocated or reserved for enhanced PRACH may be referred to herein as an enhanced PRACH resource set and a resource set allocated or reserved for unenhanced PRACH may be referred to herein as an unenhanced PRACH resource set. In some cases, a UE 115 may use a subset of resources from a defined PRACH resource set for PRACH transmission (e.g., the UE 115 may use a fraction of the PRACH resources reserved for the respective type of PRACH). The enhanced PRACH resource set and the unenhanced PRACH resource set may be associated with different parameters or configurations. For example, when PRACH repetition is enabled, different repetition levels may be associated with the enhanced and unenhanced PRACH resource sets.

UE 115-a may determine which subset of PRACH resources to use based on information from base station 105-a (e.g., information conveyed by system information block (SIB) such as PRACH configuration information, which may include a root sequence index, a PRACH configuration index, a high speed flag, a zero correlation zone configuration, and/or a PRACH frequency offset). The enhanced PRACH resource set and the unenhanced PRACH resource sets (or subsets within these two sets) may be separated by FDM and/or TDM. For example, the respective PRACH resource sets (or subsets) may be transmitted over different subbands and/or component carriers. Additionally or alternatively, the respective PRACH resource sets (or subsets) may be transmitted in different subframes.

UE 115-a may be configured to support both enhanced PRACH and unenhanced PRACH (e.g., UE 115-a may be associated with enhanced PRACH resource sets and unenhanced PRACH resource sets) or UE 115-a may be configured to support only enhanced PRACH (e.g., UE 115-a may be associated only with the enhanced PRACH resource sets). Other UEs 115 served by base station 105-a may be configured to support only unenhanced PRACH. When UE 115-a supports both enhanced and unenhanced PRACH, UE 115-a may determine which PRACH resource set to use independently or based on information from base station 105-a. In one example, UE 115-a may determine which PRACH resource set to use based on its estimated speed or an estimated Doppler condition. In some cases, the UE 115-a may compare its estimated speed or estimated Doppler condition to a corresponding threshold value (e.g., a threshold value indicated by base station 105-a, for example in a broadcast message). In some cases, base station 105-a may send an indication to UE 115-a that indicates whether selection between unenhanced PRACH and enhanced PRACH is allowed or supported.

Base station 105-a may support enhanced PRACH and/or unenhanced PRACH. Base station 105-a may determine various resources and parameters UE 115-a is to use for PRACH. For example, base station 105-a may determine a set of frequency and/or time resources to be used by UE 115-a for PRACH. For example, base station 105-a may differentiate, determine, configure, employ and/or allocate a first set of resources for unenhanced PRACH and second set of resources for enhanced PRACH (e.g., base station 105-a may differentiate between an enhanced PRACH resource set that is to be used when UE 115-a is experiencing high Doppler conditions and an unenhanced PRACH resource set that is to be used when UE 115-a is experiencing low Doppler conditions). Thus, base station 105-a may determine an enhanced PRACH resource set and an unenhanced PRACH resource set. Base station 105-a may also determine one or more particular codes (e.g., Zadoff-Chu codes) to be used by UE 115-a for PRACH.

Base station 105-a may send information to UE 115-a indicating time, frequency, and/or code resources that are available for use by UE 115-a for PRACH (e.g., base station 105-a may transmit an indication that the enhanced PRACH resource set and the unenhanced PRACH resource set are supported). In some cases, the information may explicitly indicate which resources UE 115-a is to use for PRACH. In other cases, the information may indicate a set resource of options that the UE 115-a may select from when determining which resources to use for PRACH (e.g., base station 105-a may transmit a PRACH association indicator to UE 115-a that indicates which PRACH set is to be used by UE 115-a). The PRACH association indicator may indicate that UE 115-a is to associate with the enhanced PRACH resource set only. Or the PRACH association indication may indicate to UE 115-a that UE 115-a is to associate with both the enhanced PRACH resource set and the unenhanced PRACH resource set. In some cases, the PRACH association indicator indicates that UE 115-a is to determine, based on the Doppler condition, whether to associate with the enhanced PRACH resource set or the unenhanced PRACH resource set. In some examples, the PRACH association indicator indicates whether UE 115-a may select between the enhanced PRACH resource set and the unenhanced PRACH resource set.

In some examples, base station 105-a and UE 115-a may support Doppler-specific PRACH procedures. For example, base station 105-a may select different reference signal (RS) density for physical downlink shared channel (PDSCH) and/or physical uplink shared channel (PUSCH) based on the PRACH resource set used by UE 115-a for PRACH transmission. Additionally or alternatively, base station 105-a may select different resource allocation, hopping (e.g., frequency hopping), timing advance, power control, and/or random access response time, etc., based on the PRACH resource set used by UE 115-a for PRACH transmission.

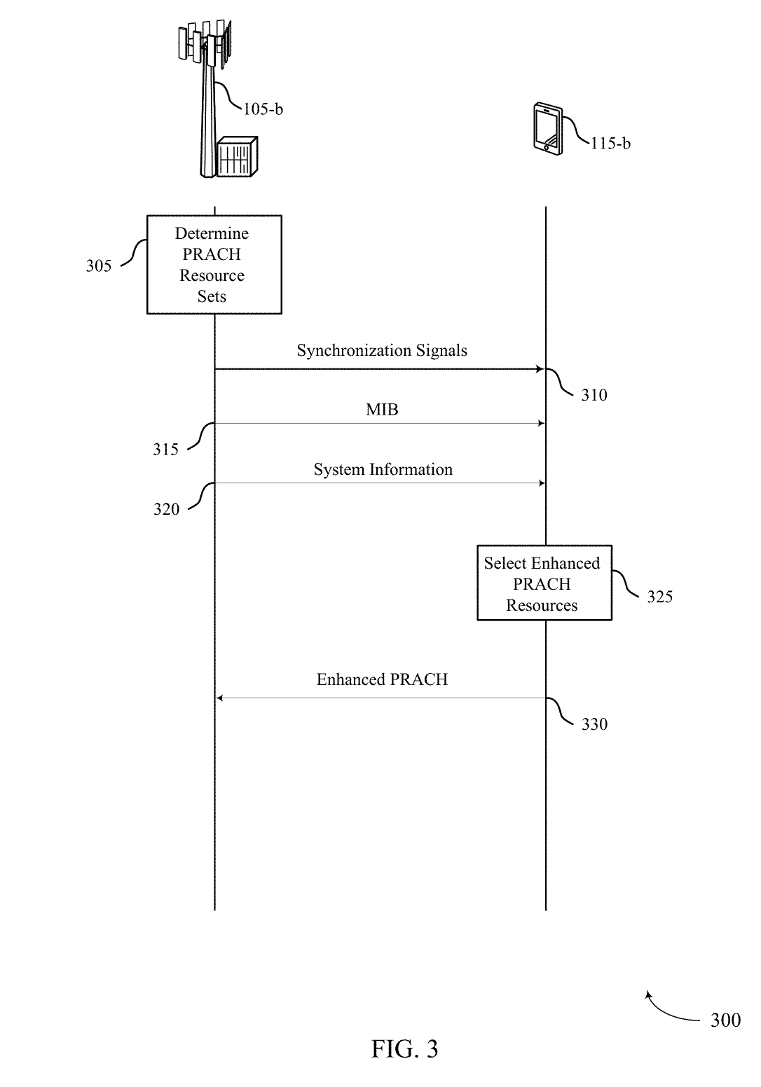

FIG. 3 illustrates an example of process flow 300 that supports high-speed RACH resource sets in accordance with aspects of the present disclosure. Process flow 300 may illustrate aspects of a random access procedure between UE 115-b and base station 105-b, which may be examples of a UE 115 and base station 105 such as described above with reference to FIGS. 1 and 2. Base station 105-b and UE 115-b may each support enhanced PRACH. Prior to, or during, the steps of process flow 300, base station 105-b may determine the abilities of UE 115-b. For example, base station 105-b may determine that UE 115-b supports enhanced PRACH. Although shown with reference to a single UE 115, the techniques described herein may be implemented for multiple UEs 115. UE 115-b may be experiencing high Doppler conditions (e.g., Doppler conditions that satisfy or exceed a threshold).

At 305, base station 105-b may determine PRACH resource sets for use in a random access procedure. For example, base station 105-b may determine an enhanced PRACH resource set and/or an unenhanced PRACH resource set. The PRACH resource sets may be resources that are available for UE 115-a to select from when transmitting PRACH. In some cases, base station 105-b may also determine specific resources within the respective PRACH resource sets that are to be used by UE 115-a. For instance, base station 105-b may determine an enhanced resource subset that UE 115-a is to use for an enhanced PRACH transmission. The PRACH resource sets (e.g., or subsets) may be separated in time and/or frequency (e.g., via FDM and/or TDM, respectively).

At 310, base station 105-a may transmit, and UE 115-b may receive, synchronization signals (e.g., primary synchronization signal (PSS) and secondary synchronization signal (SSS)). The synchronization signals convey cell information (e.g., physical cell identification (PCI) to UE 115-b and may enable UE 115-b to perform frame and time slot synchronization with base station 105-b. At 315, base station 105-b may transmit, and UE 115-b may receive, a master information block (MIB), which may include downlink channel bandwidth information, system frame number information, and physical hybrid automatic repeat request (ARQ) indicator channel (PHICH) configuration information. At 320, base station 105-b may transmit, and UE 115-b may receive, broadcast system information (e.g., system information block type 1 (SIB1) and system information block type 2 (SIB2)). UE 115-b may use the information from the MIB (e.g., PHICH configuration information) to decode physical downlink control channel (PDCCH) and read the system information.

In some cases, the system information may include an indication of the enhanced PRACH resource set determined by base station 105-b. In other cases, the system information may include an indication of a subset of resources of the enhanced PRACH resource set. In some examples, the system information may indicate that an enhanced PRACH resource set is available (e.g., the system information may indicate whether selection between unenhanced and enhanced PRACH resource sets is allowed). In some cases, the system information may include a threshold indication (e.g., a Doppler condition value). In such cases, the base station 105-b may also transmit a PRACH association indicator indicating to UE 115-b that UE 115-b is to determine, based on an estimated Doppler condition and the threshold indicated by the threshold indication, whether to associate with the enhanced PRACH resource set or the unenhanced PRACH resource set.

In some examples, the system information includes a PRACH association indicator. The PRACH association indicator may indicate that UE 115-b is to associate with the enhanced PRACH resource set only or with both the enhanced PRACH resource set and the unenhanced PRACH resource set. In some cases, the PRACH association indicator indicates that UE 115-b is to determine, based on the Doppler condition, whether to associate with the enhanced PRACH resource set or the unenhanced PRACH resource set. In some examples, the PRACH association indicator indicates whether UE 115-a may select between the enhanced PRACH resource set and the unenhanced PRACH resource set.

At 325, UE 115-b may select enhanced PRACH resources for a random access message transmission. For example, UE 115-b may select a subset of resources from the enhanced PRACH resource set. UE 115-b may select the enhanced PRACH resources from the enhanced PRACH resource set, which may be preconfigured or conveyed to UE 115-b in the system information. The selection may be autonomous or based on the system information received from base station 105-b. In one example, UE 115-b may autonomously determine which resources of the enhanced PRACH resource set to use. For example, UE 115-b may select the resources based on a comparison of its estimated Doppler condition and a Doppler condition threshold. Alternatively, UE 115-b select the resources according to instructions from base station 105-b. At 330, UE 115-b may transmit, and base station 105-b may receive, a random access message using the enhanced PRACH resource set. The enhanced resource set may be in accordance with the Doppler condition experienced by UE 115-b.

In some cases, base station 105-b may select an RS density for PDSCH and/or PUSCH transmission based at least in part on whether the random access message was received on the enhanced PRACH resource set or the unenhanced PRACH resource set. In some cases, base station 105-b may select a resource allocation, a hopping option, a timing advance, a power control, and/or a random access message response time based at least in part on whether the random access message was received on the enhanced PRACH resource set or the unenhanced PRACH resource set.

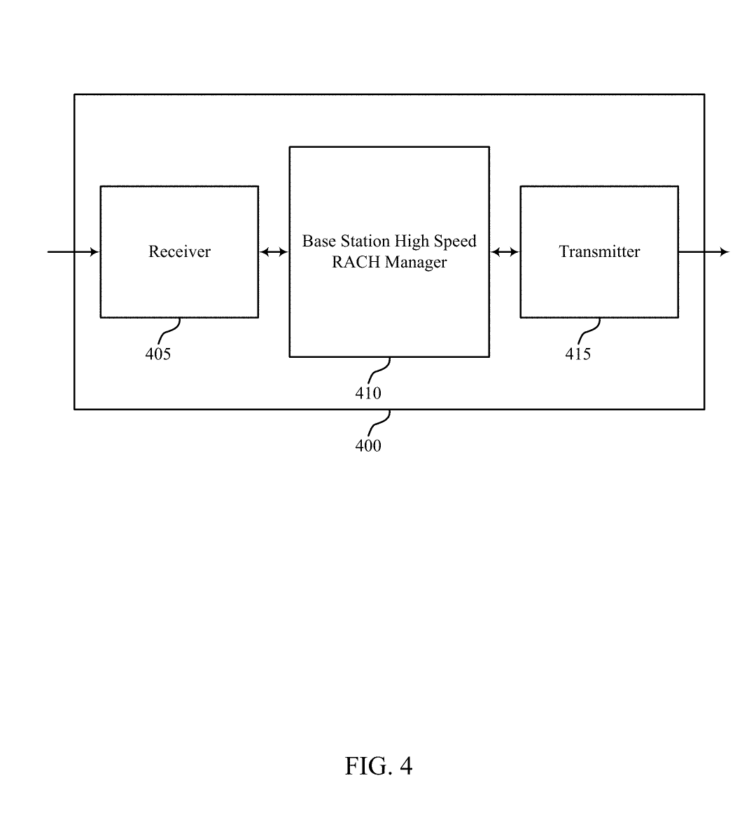

FIG. 4 shows a block diagram of a wireless device 400 that supports high-speed RACH resource sets in accordance with aspects of the present disclosure. Wireless device 400 may be an example of aspects of a base station 105 described with reference to FIGS. 1-3. Wireless device 400 may include receiver 405, base station high speed RACH manager 410 and transmitter 415. Wireless device 400 may also include a processor. Each of these components may be in communication with each other.

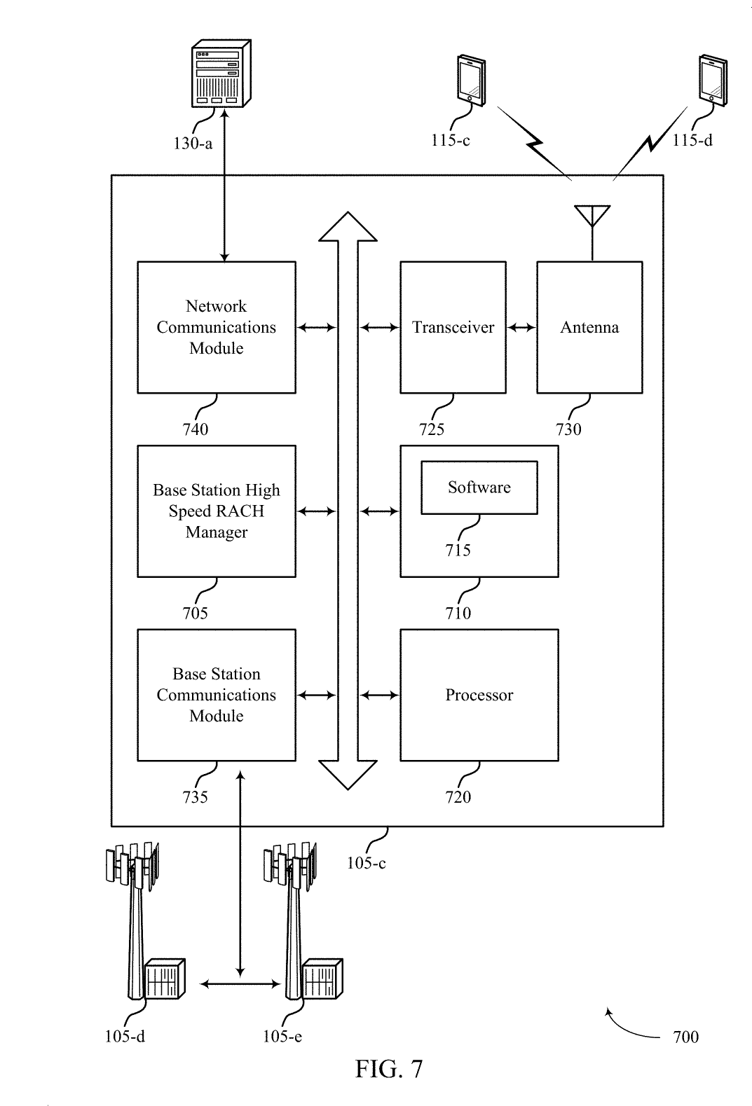

The receiver 405 may receive information such as packets, user data, or control information associated with various information channels (e.g., control channels, data channels, and information related to high-speed RACH resource sets, etc.). In some cases, the receiver 405 may receive random access messages over enhanced PRACH resource sets and unenhanced resource sets such as described herein. Information may be passed on to other components of the wireless device 400. The receiver 405 may be an example of aspects of the transceiver 725 described with reference to FIG. 7. The transmitter 415 may transmit signals received from other components of wireless device 400. In some cases, the transmitter 415 may transmit system information to a UE 115 such as described herein. In some examples, the transmitter 415 may be collocated with a receiver in a transceiver module. For example, the transmitter 415 may be an example of aspects of the transceiver 725 described with reference to FIG. 7. The transmitter 415 may include a single antenna or it may include a plurality of antennas.

The base station high speed RACH manager 410 may differentiate between a first (e.g., enhanced) PRACH resource set to be used by one or more UEs experiencing a Doppler condition that exceeds a threshold and a second (e.g., unenhanced) PRACH resource set to be used by one or more UEs experiencing a Doppler condition that is less than the threshold. The base station high speed RACH manager 410 may direct the transmitter 415 to transmit an indication that the first PRACH resource set and the second PRACH resource set are supported. The base station high speed RACH manager 410 may also be an example of aspects of the base station high speed RACH manager 705 described with reference to FIG. 7.

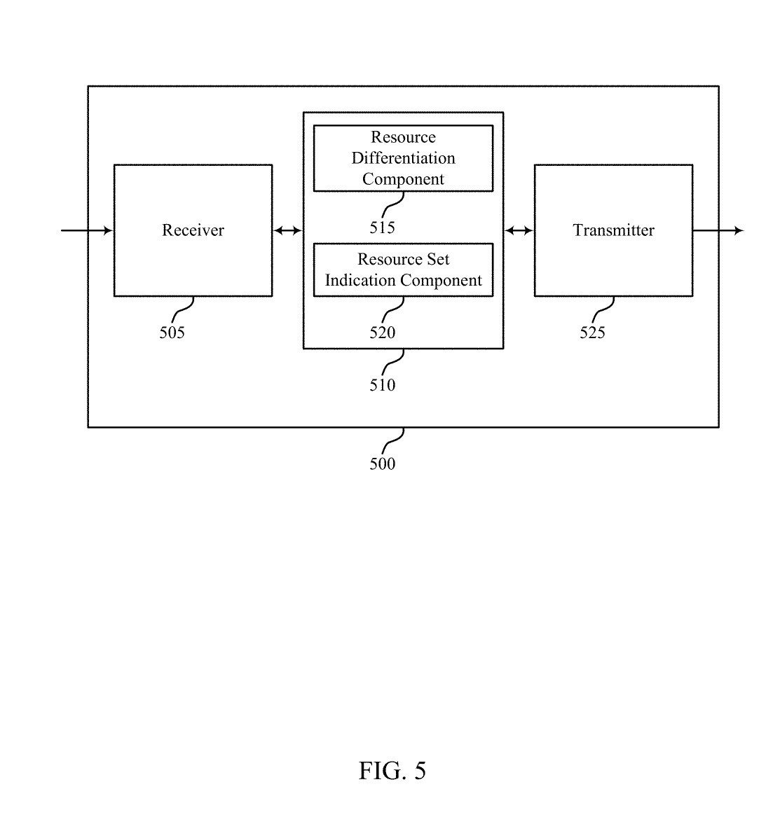

FIG. 5 shows a block diagram of a wireless device 500 that supports high-speed RACH resource sets in accordance with aspects of the present disclosure. Wireless device 500 may be an example of aspects of a wireless device 400 or a base station 105 described with reference to FIGS. 1-4. Wireless device 500 may include receiver 505, base station high speed RACH manager 510 and transmitter 525. Wireless device 500 may also include a processor. Each of these components may be in communication with each other.

The receiver 505 may receive information which may be passed on to other components of wireless device 500. The receiver 505 may also perform the functions described with reference to the receiver 405 of FIG. 4. The receiver 505 may be an example of aspects of the transceiver 725 described with reference to FIG. 7. The transmitter 525 may transmit signals received from other components of wireless device 500. In some examples, the transmitter 525 may be collocated with a receiver in a transceiver module. For example, the transmitter 525 may be an example of aspects of the transceiver 725 described with reference to FIG. 7. The transmitter 525 may utilize a single antenna or it may utilize a plurality of antennas.

The base station high speed RACH manager 510 may be an example of aspects of base station high speed RACH manager 410 described with reference to FIG. 4. The base station high speed RACH manager 510 may include resource differentiation component 515 and resource set indication component 520. The base station high speed RACH manager 510 may be an example of aspects of the base station high speed RACH manager 705 described with reference to FIG. 7.

The resource differentiation component 515 may differentiate between a first (e.g., enhanced) PRACH resource set to be used by one or more UEs experiencing a Doppler condition that satisfies or exceeds a threshold and a second (e.g., unenhanced) PRACH resource set to be used by one or more UEs experiencing a Doppler condition that is less than the threshold. In some cases, differentiating between the first PRACH resource set and the second PRACH resource set includes using FDM to separate the first PRACH resource set and the second PRACH resource set. Using FDM to separate the first and second PRACH resource sets may include separating the first PRACH resource set from the second PRACH resource set using different frequency ranges, subbands, and/or component carriers (CCs).

In some cases, differentiating between the first PRACH resource set and the second PRACH resource set includes using TDM to separate the first PRACH resource set and the second PRACH resource set. In some cases, using TDM includes separating the first PRACH resource set from the second PRACH resources set using different subframes or different portions of a subframe. In some cases, differentiating between the first PRACH resource set and the second PRACH resource set includes using a first repetition level (e.g., a number of times a preamble is to be transmitted during a RACH procedure) associated with the first PRACH resource set and a second repetition level associated with the second PRACH resource set.

The resource set indication component 520 may communicate with the transmitter 525 to facilitate transmission of an indication that the first PRACH resource set and the second PRACH resource set are supported. In some cases, the indication is part of a SIB transmission.

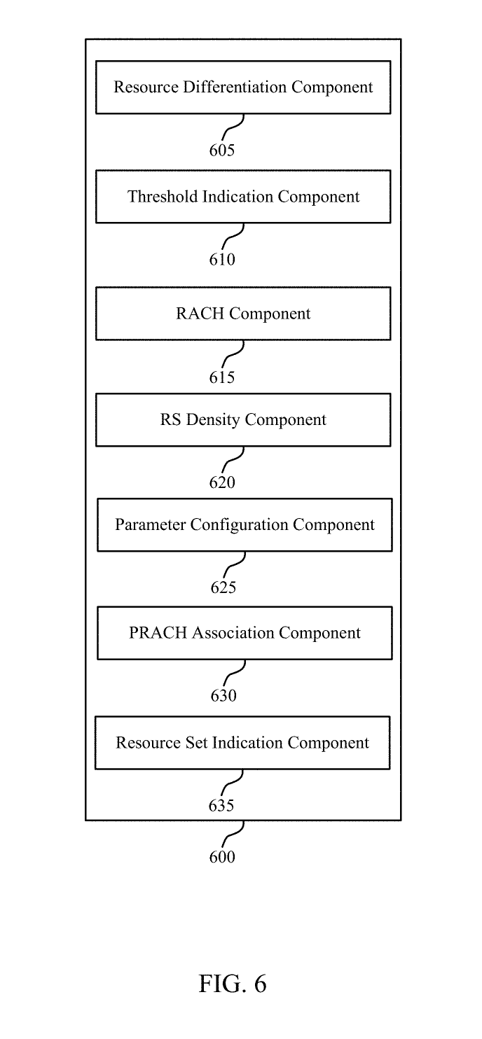

FIG. 6 shows a block diagram of a base station high speed RACH manager 600 which may be an example of the corresponding component of wireless device 400 or wireless device 500. That is, base station high speed RACH manager 600 may be an example of aspects of base station high speed RACH manager 410 or base station high speed RACH manager 510 described with reference to FIGS. 4 and 5. The base station high speed RACH manager 600 may also be an example of aspects of the base station high speed RACH manager 705 described with reference to FIG. 7.

The base station high speed RACH manager 600 may include PRACH association component 630, threshold indication component 610, RACH component 615, RS density component 620, parameter configuration component 625, resource differentiation component 605 and resource set indication component 635. Each of these modules may communicate, directly or indirectly, with one another (e.g., via one or more buses).

The resource differentiation component 605 may differentiate between a first (e.g., enhanced) PRACH resource set to be used by one or more UEs experiencing a Doppler condition that satisfies or exceeds a threshold and a second (e.g., unenhanced) PRACH resource set to be used by one or more UEs experiencing a Doppler condition that does not satisfy or is less than the threshold. In some cases, the resource differentiation component 605 may differentiate between a first PRACH resource set and a second PRACH resource set. The first PRACH resource set may be used by UEs experiencing a higher Doppler condition than UEs using the second PRACH resource set

The threshold indication component 610 may facilitate transmission of a threshold indication to a UE. In some cases, the PRACH association component 630 may facilitate transmission of a PRACH association indicator to a UE indicating to the UE one or more of the first PRACH resource set or the second PRACH resource set to be used by the UE. In some cases, the PRACH association indicator indicates to the UE that the UE is to determine, based on the Doppler condition and the threshold indicated by the threshold indication, whether to associate with the first PRACH resource set or the second PRACH resource set. In some cases, the PRACH association indicator indicates that the UE is to associate with the first PRACH resource set only. In some cases, the PRACH association indicator indicates that the UE is to associate with both the first PRACH resource set and the second PRACH resource set. In some cases, the PRACH association indicator indicates that the UE is to determine, based on the Doppler condition, whether to associate with the first PRACH resource set or the second PRACH resource set. In some cases, the PRACH association indicator indicates whether the UE may select between the first PRACH resource set and the second PRACH resource set.

The resource set indication component 635 may facilitate transmission of an indication that the first PRACH resource set and the second PRACH resource set are supported. In some cases, transmitting the indication includes including the indication as part of a SIB transmission.

The RACH component 615 may receive a random access message from a UE using one of the first PRACH resource set or the second PRACH resource set in accordance with the Doppler condition experienced by the UE. In some cases, the RACH component 615 may receive a random access message from a UE using one of the first PRACH resource set or the second PRACH resource set in accordance with the Doppler condition experienced by the UE, and receive a random access message from a UE using one of the first PRACH resource set or the second PRACH resource set in accordance with the Doppler condition experienced by the UE.

The RS density component 620 may select a RS density for at least one of PDSCH or PUSCH transmission based on whether the random access message was received on the first PRACH resource set or the second PRACH resource set. The parameter configuration component 625 may select at least one of a resource allocation, a hopping option, a timing advance, a power control, or a random access message response time based on whether the random access message was received on the first PRACH resource set or the second PRACH resource set.

FIG. 7 shows a diagram of a wireless system 700 including a device that supports high-speed RACH resource sets in accordance with aspects of the present disclosure. For example, wireless system 700 may include base station 105-c, which may be an example of a wireless device 400, a wireless device 500, or a base station 105 as described with reference to FIGS. 1-6. Base station 105-c may also include components for bi-directional voice and data communications including components for transmitting communications and components for receiving communications. For example, base station 105-c may communicate bi-directionally with one or more UEs 115 (e.g., UE 115-c and/or UE 115-d).

Base station 105-c may also include base station high speed RACH manager 705, memory 710, processor 720, transceiver 725, antenna 730, base station communications module 735 and network communications module 740. Each of these modules may communicate, directly or indirectly, with one another (e.g., via one or more buses). The base station high speed RACH manager 705 may be an example of a base station high speed RACH manager as described with reference to FIGS. 4 through 6.

The memory 710 may include random access memory (RAM) and read only memory (ROM). The memory 710 may store computer-readable, computer-executable software including one or more instructions that, when executed, cause the processor to perform various functions described herein (e.g., high-speed RACH resource sets, etc.). In some cases, the software 715 may not be directly executable by the processor but may cause a computer (e.g., when compiled and executed) to perform functions described herein. The processor 720 may include an intelligent hardware device, (e.g., a central processing unit (CPU), a microcontroller, an application specific integrated circuit (ASIC), etc.).

The transceiver 725 may communicate bi-directionally, via one or more antennas, wired, or wireless links, with one or more networks, as described above. For example, the transceiver 725 may communicate bi-directionally with a base station 105 or a UE 115. The transceiver 725 may also include a modem to modulate the packets and provide the modulated packets to the antennas for transmission, and to demodulate packets received from the antennas. In some cases, base station 105-c may include a single antenna 730. However, in some cases base station 105-c may have more than one antenna 730, which may be capable of concurrently transmitting or receiving multiple wireless transmissions.

The base station communications module 735 may manage communications with other base stations 105 (e.g., base station 105-d and/or base station 105-e), and may include a controller or scheduler for controlling communications with UEs 115 in cooperation with other base stations 105. For example, the base station communications module 735 may coordinate scheduling for transmissions to UEs 115 for various interference mitigation techniques such as beamforming or joint transmission. In some examples, base station communications module 735 may provide an X2 interface within an LTE/LTE-A wireless communication network technology to provide communication between base stations 105.

The network communications module 740 may manage communications with the core network (e.g., via one or more wired backhaul links). For example, the network communications module 740 may manage the transfer of data communications for client devices, such as one or more UEs 115.

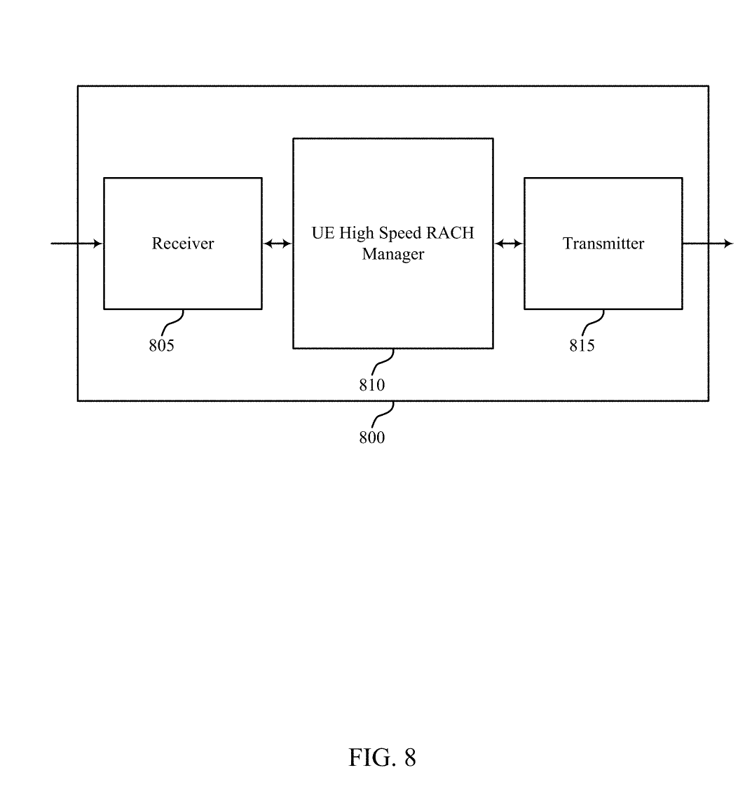

FIG. 8 shows a block diagram of a wireless device 800 that supports high-speed RACH resource sets in accordance with aspects of the present disclosure. Wireless device 800 may be an example of aspects of a UE 115 described with reference to FIGS. 1-3. Wireless device 800 may include receiver 805, UE high speed RACH manager 810 and transmitter 815. Wireless device 800 may also include a processor. Each of these components may be in communication with each other.

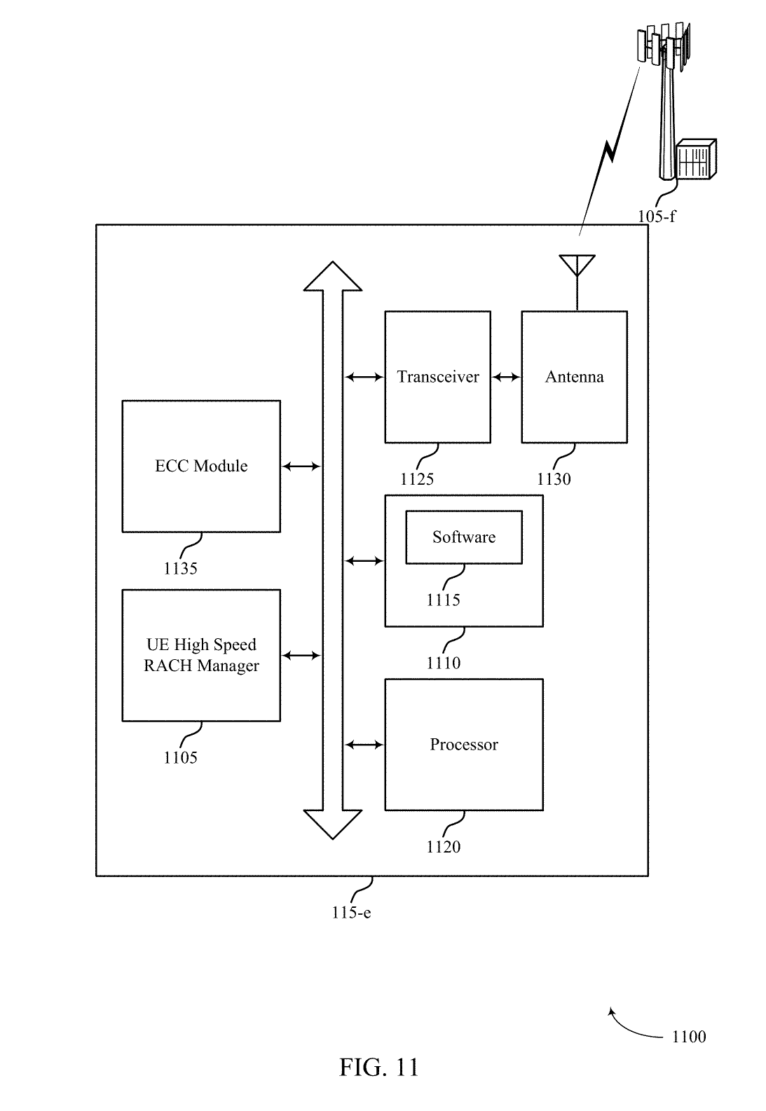

The receiver 805 may receive information such as packets, user data, or control information associated with various information channels (e.g., control channels, data channels, and information related to high-speed RACH resource sets, etc.). The receiver 805 may receive RACH association indicators and PRACH resource set indications from a base station as described herein. Information may be passed on to other components of wireless device 800. The receiver 805 may be an example of aspects of the transceiver 1125 described with reference to FIG. 11. The transmitter 815 may transmit signals received from other components of wireless device 800. The transmitter 815 may transmit random access messages over enhanced and unenhanced PRACH resources sets as described herein. In some examples, the transmitter 815 may be collocated with a receiver in a transceiver module. For example, the transmitter 815 may be an example of aspects of the transceiver 1125 described with reference to FIG. 11. The transmitter 815 may include a single antenna, or it may include a plurality of antennas.

The UE high speed RACH manager 810 may receive an indication that a first PRACH resource set to be used by UEs experiencing a Doppler condition that satisfies or exceeds a threshold and a second PRACH resource set to be used by UEs experiencing a Doppler condition that does not satisfy or is less than the threshold are supported. The UE high speed RACH manager 810 may facilitate the transmission of a random access message using one of the first PRACH resource set or the second PRACH resource set in accordance with an experienced Doppler condition. The UE high speed RACH manager 810 may also be an example of aspects of the UE high speed RACH manager 1105 described with reference to FIG. 11.

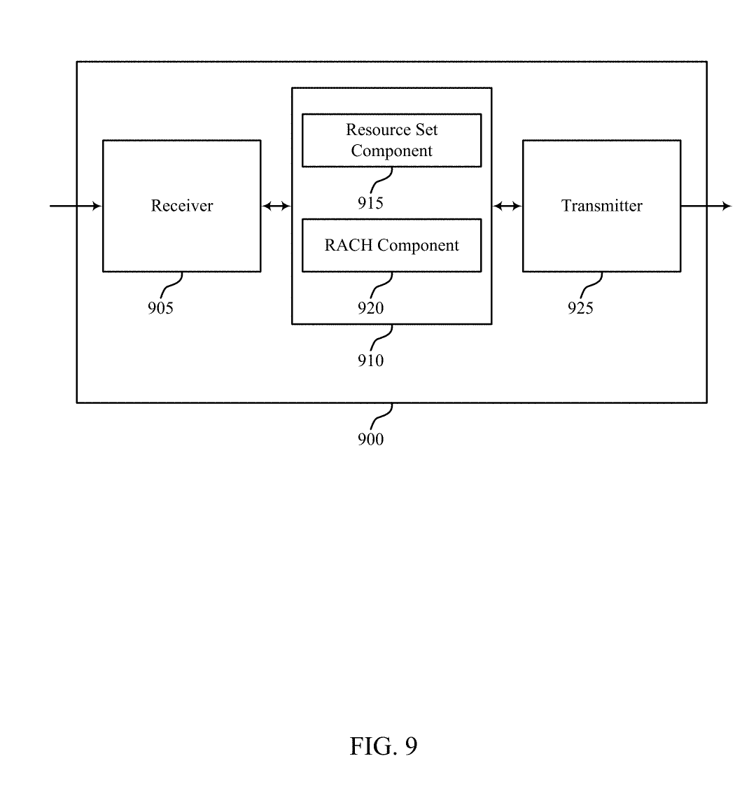

FIG. 9 shows a block diagram of a wireless device 900 that supports high-speed RACH resource sets in accordance with aspects of the present disclosure. Wireless device 900 may be an example of aspects of a wireless device 800 or a UE 115 described with reference to FIGS. 1-3 and 8. Wireless device 900 may include receiver 905, UE high speed RACH manager 910 and transmitter 925. Wireless device 900 may also include a processor. Each of these components may be in communication with each other.

The receiver 905 may receive information which may be passed on to other components of wireless device 900. The receiver 905 may also perform the functions described with reference to the receiver 805 of FIG. 8. The receiver 905 may be an example of aspects of the transceiver 1125 described with reference to FIG. 11. The transmitter 925 may transmit signals received from other components of wireless device 900. In some examples, the transmitter 925 may be collocated with a receiver in a transceiver module. For example, the transmitter 925 may be an example of aspects of the transceiver 1125 described with reference to FIG. 11. The transmitter 925 may utilize a single antenna, or it may utilize a plurality of antennas.

The UE high speed RACH manager 910 may be an example of aspects of UE high speed RACH manager 810 described with reference to FIG. 8. The UE high speed RACH manager 910 may include resource set component 915 and RACH component 920. The UE high speed RACH manager 910 may be an example of aspects of the UE high speed RACH manager 1105 described with reference to FIG. 11.

The resource set component 915 may receive an indication that a first PRACH resource set to be used by UEs experiencing a Doppler condition that satisfies or exceeds a threshold and a second PRACH resource set to be used by UEs experiencing a Doppler condition that does not satisfy or is less than the threshold are supported.

The RACH component 920 may facilitate transmission of a random access message using one of the first PRACH resource set or the second PRACH resource set in accordance with an experienced Doppler condition. In some cases, transmitting the random access message includes transmitting the random access message using one or more frequency ranges, subbands and/or CCs that are associated with one of the first PRACH resource set or the second PRACH resource set. In some cases, transmitting the random access message includes transmitting the random access message using one or more subframes or portions of a subframe that are associated with one of the first PRACH resource set or the second PRACH resource set. In some cases, transmitting the random access message includes transmitting the random access message using a repetition level associated with one of the first PRACH resource set or the second PRACH resource set.

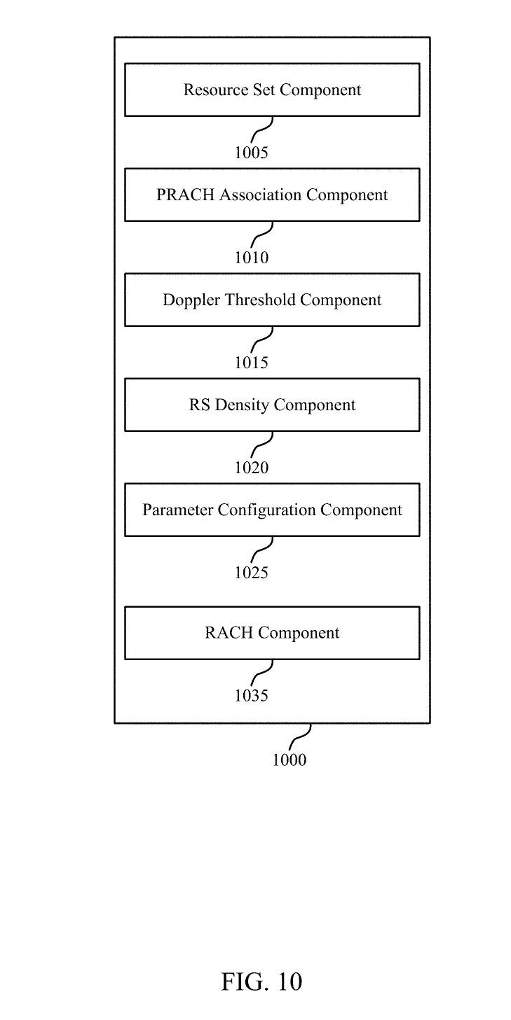

FIG. 10 shows a block diagram of a UE high speed RACH manager 1000 which may be an example of the corresponding component of wireless device 800 or wireless device 900. That is, UE high speed RACH manager 1000 may be an example of aspects of UE high speed RACH manager 810 or UE high speed RACH manager 910 described with reference to FIGS. 8 and 9. The UE high speed RACH manager 1000 may also be an example of aspects of the UE high speed RACH manager 1105 described with reference to FIG. 11.

The UE high speed RACH manager 1000 may include resource set component 1005, PRACH association component 1010, Doppler threshold component 1015, RS density component 1020, parameter configuration component 1025, and RACH component 1035. Each of these modules may communicate, directly or indirectly, with one another (e.g., via one or more buses).

The resource set component 1005 may receive an indication that a first PRACH resource set to be used by UEs experiencing a Doppler condition that satisfies or exceeds a threshold and a second PRACH resource set to be used by UEs experiencing a Doppler condition that does not satisfy or is less than the threshold are supported. In some cases, receiving the indication includes receiving the indication as part of a SIB transmission. In some cases, the resource set component 1005 may receive an indication that a first PRACH and a second PRACH resource set are supported. The first PRACH resource set may be allocated for use by UEs experiencing a higher Doppler condition than UEs using the second PRACH resource set. In aspects, a UE using the second PRACH resource set may experience a high Doppler condition.

The PRACH association component 1010 may receive a PRACH association indicator indicating one or more of the first PRACH resource set or the second PRACH resource set to be used. In some cases, the PRACH association indicator indicates to the UE that the UE is to determine, based on the Doppler condition and the threshold indicated by the threshold indication, whether to associate with the first PRACH resource set or the second PRACH resource set. In some cases, the PRACH association indicator indicates that the UE is to associate with the first PRACH resource set only. In some cases, the PRACH association indicator indicates that the UE is to associate with both the first PRACH resource set and the second PRACH resource set. In some cases, the PRACH association indicator indicates that the UE is to determine, based on the Doppler condition, whether to associate with the first PRACH resource set or the second PRACH resource set. In some cases, the PRACH association indicator indicates whether the UE may select between the first PRACH resource set and the second PRACH resource set.

The Doppler threshold component 1015 may receive a threshold indication. The RS density component 1020 may receive at least one of PDSCH or PUSCH configuration having a RS density based on whether the random access message was transmitted on the first PRACH resource set or the second PRACH resource set. The parameter configuration component 1025 may receive a resource allocation, a hopping option, a timing advance, and/or a power control configuration based on whether the random access message was received on the first PRACH resource set or the second PRACH resource set. In some cases, the UE may communicate using the indicated resource allocation, hopping option, timing advance, and/or power control configuration based on whether the random access message was received on the first PRACH resource set or the second PRACH resource set. The RACH component 1035 may transmit a random access message using one of the first PRACH resource set or the second PRACH resource set in accordance with an experienced Doppler condition.

FIG. 11 shows a diagram of a wireless system 1100 including a device that supports high-speed RACH resource sets in accordance with aspects of the present disclosure. For example, wireless system 1100 may include UE 115-e, which may be an example of a wireless device 800, a wireless device 900, or a UE 115 as described with reference to FIGS. 1-3 and 8-10.

UE 115-e may also include UE high speed RACH manager 1105, memory 1110, processor 1120, transceiver 1125, antenna 1130, and ECC module 1135. Each of these modules may communicate, directly or indirectly, with one another (e.g., via one or more buses). The UE high speed RACH manager 1105 may be an example of a UE high speed RACH manager as described with reference to FIGS. 8 through 10.

The memory 1110 may include RAM and ROM. The memory 1110 may store computer-readable, computer-executable software including one or more instructions that, when executed, cause the processor to perform various functions described herein (e.g., functions related to the use of high-speed RACH resource sets, etc.). In some cases, the software 1115 may not be directly executable by the processor but may cause a computer (e.g., when compiled and executed) to perform functions described herein. The processor 1120 may include an intelligent hardware device, (e.g., a CPU, a microcontroller, an ASIC, etc.). ECC module 1135 may enable operations using enhanced component carriers (eCCs) such as communication using shared or unlicensed spectrum, using reduced TTIs or subframe durations, or using a large number of component carriers.

The transceiver 1125 may communicate bi-directionally, via one or more antennas, wired, or wireless links, with one or more networks, as described above. For example, the transceiver 1125 may communicate bi-directionally with a base station 105 or a UE 115. The transceiver 1125 may also include a modem to modulate the packets and provide the modulated packets to the antennas for transmission, and to demodulate packets received from the antennas. In some cases, the wireless device may include a single antenna 1130. However, in some cases the device may have more than one antenna 730, which may be capable of concurrently transmitting or receiving multiple wireless transmissions.

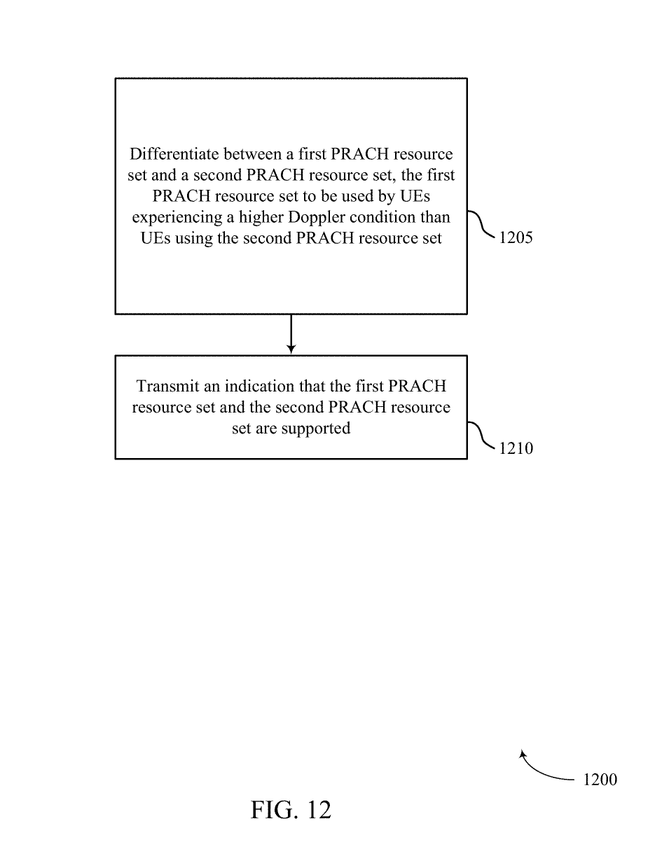

FIG. 12 shows a flowchart illustrating a method 1200 for high-speed RACH resource sets in accordance with aspects of the present disclosure. The operations of method 1200 may be implemented by a device such as a base station 105 or its components as described with reference to FIGS. 1-3. For example, the operations of method 1200 may be performed by the base station high speed RACH manager as described herein. In some examples, the base station 105 may execute a set of one or more codes to control the functional elements of the device to perform the functions described below. Additionally or alternatively, the base station 105 may perform aspects the functions described below using special-purpose hardware.

At block 1205, the base station 105 may differentiate between a first PRACH resource set and a second PRACH resource set, the first PRACH resource set to be used by UEs experiencing a higher Doppler condition than UEs using the second PRACH resource set as described above with reference to FIGS. 2 through 3. In certain examples, the operations of block 1205 may be performed by the resource differentiation component as described with reference to FIGS. 5 and 6. At block 1210, the base station 105 may transmit an indication that the first PRACH resource set and the second PRACH resource set are supported as described above with reference to FIGS. 2 through 3. In certain examples, the operations of block 1210 may be performed by the resource set indication component as described with reference to FIGS. 5 and 6.

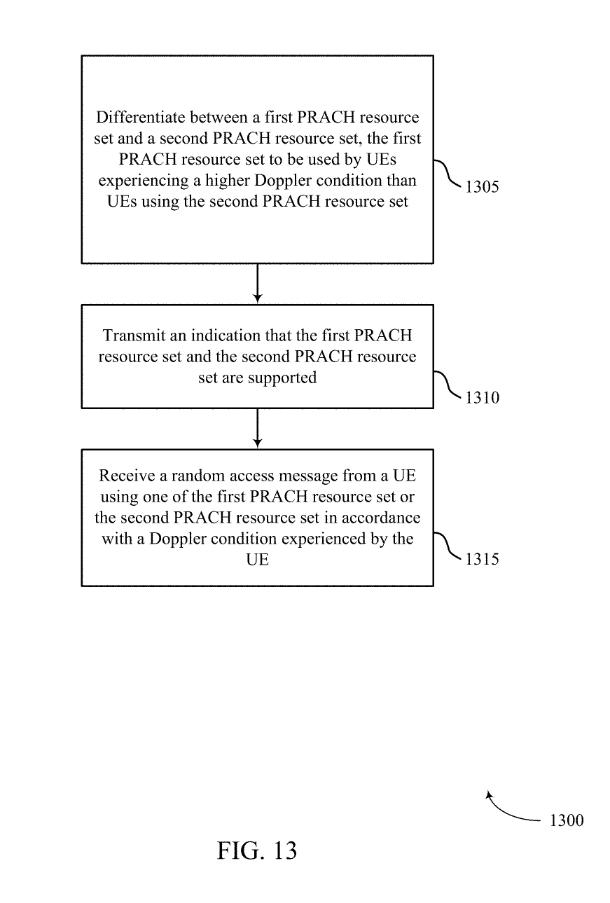

FIG. 13 shows a flowchart illustrating a method 1300 for high-speed RACH resource sets in accordance with aspects of the present disclosure. The operations of method 1300 may be implemented by a device such as a base station 105 or its components as described with reference to FIGS. 1-3. For example, the operations of method 1300 may be performed by the base station high speed RACH manager as described herein. In some examples, the base station 105 may execute a set of one or more codes to control the functional elements of the device to perform the functions described below. Additionally or alternatively, the base station 105 may perform aspects the functions described below using special-purpose hardware.

At block 1305, the base station 105 may differentiate between a first PRACH resource set and a second PRACH resource set, the first PRACH resource set to be used by UEs experiencing a higher Doppler condition than UEs using the second PRACH resource set as described above with reference to FIGS. 2 through 3. In certain examples, the operations of block 1305 may be performed by the resource differentiation component as described with reference to FIGS. 5 and 6.

At block 1310, the base station 105 may transmit an indication that the first PRACH resource set and the second PRACH resource set are supported as described above with reference to FIGS. 2 through 3. In certain examples, the operations of block 1310 may be performed by the resource set indication component as described with reference to FIGS. 5 and 6. At block 1315, the base station 105 may receive a random access message from a UE using one of the first PRACH resource set or the second PRACH resource set in accordance with a Doppler condition experienced by the UE as described above with reference to FIGS. 2 through 3. In certain examples, the operations of block 1315 may be performed by the RACH component as described with reference to FIGS. 5 and 6.

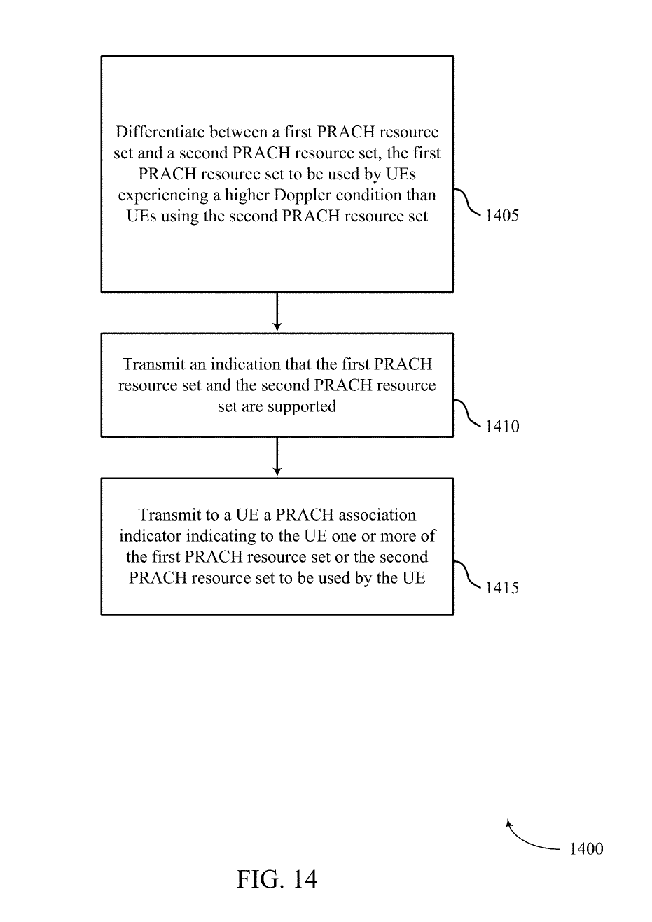

FIG. 14 shows a flowchart illustrating a method 1400 for high-speed RACH resource sets in accordance with aspects of the present disclosure. The operations of method 1400 may be implemented by a device such as a base station 105 or its components as described with reference to FIGS. 1-3. For example, the operations of method 1400 may be performed by the base station high speed RACH manager as described herein. In some examples, the base station 105 may execute a set of one or more codes to control the functional elements of the device to perform the functions described below. Additionally or alternatively, the base station 105 may perform aspects the functions described below using special-purpose hardware.

At block 1405, the base station 105 may determine, configure, employ, differentiate between, and/or allocate a first PRACH resource set and a second PRACH resource set, the first PRACH resource set to be used by UEs experiencing a higher Doppler condition than UEs using the second PRACH resource set as described above with reference to FIGS. 2 through 3. In certain examples, the operations of block 1405 may be performed by the resource differentiation component as described with reference to FIGS. 5 and 6.

At block 1410, the base station 105 may transmit an indication that the first PRACH resource set and the second PRACH resource set are supported as described above with reference to FIGS. 2 through 3. In certain examples, the operations of block 1410 may be performed by the resource set indication component as described with reference to FIGS. 5 and 6. At block 1415, the base station 105 may transmit to a UE 115 a PRACH association indicator indicating to the UE one or more of the first PRACH resource set or the second PRACH resource set to be used by the UE as described above with reference to FIGS. 2 through 3. In certain examples, the operations of block 1415 may be performed by the PRACH association component as described with reference to FIGS. 5 and 6.

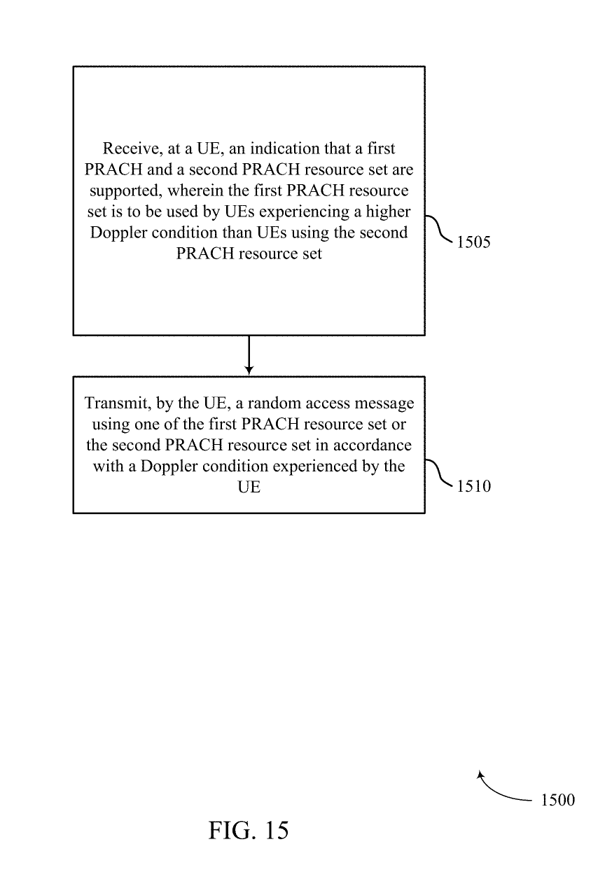

FIG. 15 shows a flowchart illustrating a method 1500 for high-speed RACH resource sets in accordance with aspects of the present disclosure. The operations of method 1500 may be implemented by a device such as a UE 115 or its components as described with reference to FIGS. 1-3. For example, the operations of method 1500 may be performed by the UE high speed RACH manager as described herein. In some examples, the UE 115 may execute a set of codes to control the functional elements of the device to perform the functions described below. Additionally or alternatively, the UE 115 may perform aspects the functions described below using special-purpose hardware.

At block 1505, the UE 115 may receive an indication that a first PRACH and a second PRACH resource set are supported, wherein the first PRACH resource set is to be used by UEs experiencing a higher Doppler condition than UEs using the second PRACH resource set as described above with reference to FIGS. 2 through 3. In certain examples, the operations of block 1505 may be performed by the resource set component as described with reference to FIGS. 9 and 10. At block 1510, the UE 115 may transmit a random access message using one of the first PRACH resource set or the second PRACH resource set in accordance with a Doppler condition experienced by the UE 115 as described above with reference to FIGS. 2 through 3. In certain examples, the operations of block 1510 may be performed by the RACH component as described with reference to FIGS. 9 and 10.

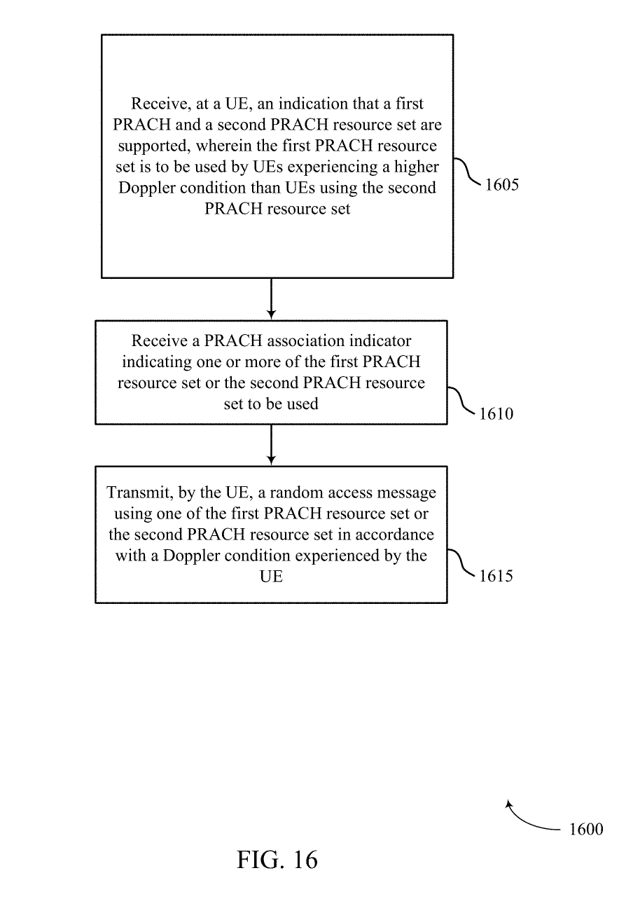

FIG. 16 shows a flowchart illustrating a method 1600 for high-speed RACH resource sets in accordance with aspects of the present disclosure. The operations of method 1600 may be implemented by a device such as a UE 115 or its components as described with reference to FIGS. 1-3. For example, the operations of method 1600 may be performed by the UE high speed RACH manager as described herein. In some examples, the UE 115 may execute a set of one or more codes to control the functional elements of the device to perform the functions described below. Additionally or alternatively, the UE 115 may perform aspects the functions described below using special-purpose hardware.

At block 1605, the UE 115 may receive an indication that a first PRACH and a second PRACH resource set are supported, wherein the first PRACH resource set is to be used by UEs experiencing a higher Doppler condition than UEs using the second PRACH resource set as described above with reference to FIGS. 2 through 3. In certain examples, the operations of block 1605 may be performed by the resource set component as described with reference to FIGS. 9 and 10.

At block 1610, the UE 115 may receive a PRACH association indicator indicating one or more of the first PRACH resource set or the second PRACH resource set to be used as described above with reference to FIGS. 2 through 3. In certain examples, the operations of block 1610 may be performed by the PRACH association component as described with reference to FIGS. 9 and 10. At block 1615, the UE 115 may transmit a random access message using one of the first PRACH resource set or the second PRACH resource set in accordance with a Doppler condition experienced by the UE 115 as described above with reference to FIGS. 2 through 3. In certain examples, the operations of block 1615 may be performed by the RACH component as described with reference to FIGS. 9 and 10.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for high-speed RACH resource sets.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Techniques described herein may be used for various wireless communications systems such as CDMA, TDMA, FDMA, OFDMA, single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as (Global System for Mobile communications (GSM)). An OFDMA system may implement a radio technology such as Ultra Mobile Broadband (UMB), Evolved UTRA (E-UTRA), IEEE 802.11, IEEE 802.16 (WiMAX), IEEE 802.20, Flash-OFDM, etc. UTRA and E-UTRA are part of Universal Mobile Telecommunications system (Universal Mobile Telecommunications System (UMTS)). 3GPP LTE and LTE-advanced (LTE-A) are new releases of UMTS that use E-UTRA. UTRA, E-UTRA, UMTS, LTE, LTE-a, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description herein, however, describes an LTE system for purposes of example, and LTE terminology is used in much of the description above, although the techniques are applicable beyond LTE applications.

In LTE/LTE-A networks, including networks described herein, the term evolved node B (eNB) may be generally used to describe the base stations. The wireless communications system or systems described herein may include a heterogeneous LTE/LTE-A network in which different types of eNBs provide coverage for various geographical regions. For example, each eNB or base station may provide communication coverage for a macro cell, a small cell, or other types of cell. The term “cell” is a 3GPP term that can be used to describe a base station, a carrier or component carrier (CC) associated with a base station, or a coverage area (e.g., sector, etc.) of a carrier or base station, depending on context.

Base stations may include or may be referred to by those skilled in the art as a base transceiver station, a radio base station, an access point (AP), a radio transceiver, a NodeB, eNodeB (eNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, relay base stations, and the like. There may be overlapping geographic coverage areas for different technologies. In some cases, different coverage areas may be associated with different communication technologies.

In some cases, the coverage area for one communication technology may overlap with the coverage area associated with another technology. Different technologies may be associated with the same base station, or with different base stations.

A macro cell generally covers a relatively large geographic area (e.g., several kilometers in radius) and may allow unrestricted access by UEs with service subscriptions with the network provider. A small cell is a lower-powered base stations, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., CCs). A UE may be able to communicate with various types of base stations and network equipment including macro eNBs, small cell eNBs, relay base stations, and the like.

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The DL transmissions described herein may also be called forward link transmissions while the UL transmissions may also be called reverse link transmissions. Each communication link described herein including, for example, wireless communications system 100 and 200 of FIGS. 1 and 2 may include one or more carriers, where each carrier may be a signal made up of multiple sub-carriers (e.g., waveform signals of different frequencies). Each modulated signal may be sent on a different sub-carrier and may carry control information (e.g., reference signals, control channels, etc.), overhead information, user data, etc. The communication links described herein (e.g., communication links 125 of FIG. 1) may transmit bidirectional communications using FDD (e.g., using paired spectrum resources) or TDD operation (e.g., using unpaired spectrum resources). Frame structures may be defined for FDD (e.g., frame structure type 1) and TDD (e.g., frame structure type 2).

Thus, aspects of the disclosure may provide for high-speed RACH resource sets. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: a, b, or c” is intended to cover a, b, c, a-b, a-c, b-c, and a-b-c., as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of wireless communication comprising:
receiving, at a user equipment (UE), an indication that a first physical random access channel (PRACH) and a second PRACH resource set are supported, wherein the first PRACH resource set is to be used by UEs experiencing a higher Doppler condition than UEs using the second PRACH resource set; and
transmitting, by the UE, a random access message using one of the first PRACH resource set or the second PRACH resource set in accordance with a Doppler condition experienced by the UE.

2. The method of claim 1, wherein the first PRACH resource set is to be used by UEs experiencing a Doppler condition that satisfies a threshold and the second PRACH resource set is to be used by UEs experiencing a Doppler condition that is less than the threshold.

3. The method of claim 1, wherein the first PRACH resource set is associated with a first cyclic shift that is detectable at a first range of speeds and the second PRACH resource set is associated with a second cyclic shift that is detectable at a second range of speeds slower than the first range of speeds.

4. The method of claim 1, wherein transmitting the random access message comprises: transmitting the random access message using a repetition level associated with one of the first PRACH resource set or the second PRACH resource set.

5. The method of claim 1, further comprising:
receiving a PRACH association indicator indicating one or more of the first PRACH resource set or the second PRACH resource set to be used.

6. The method of claim 5, wherein the PRACH association indicator indicates that the UE is to determine, based on the Doppler condition experienced by the UE, whether to associate with the first PRACH resource set or the second PRACH resource set.

7. The method of claim 1, further comprising:
receiving a threshold indication; and
receiving a PRACH association indicator indicating to the UE that the UE is to determine, based on the Doppler condition experienced by the UE and the threshold indicated by the threshold indication, whether to associate with the first PRACH resource set or the second PRACH resource set.

8. The method of claim 1, further comprising:
receiving at least one of physical downlink shared channel (PDSCH) or physical uplink shared channel (PUSCH) configuration having a reference signal (RS) density based at least in part on whether the random access message was transmitted on the first PRACH resource set or the second PRACH resource set.

9. The method of claim 1, further comprising:
receiving at least one of a resource allocation, a hopping option, a timing advance, or a power control configuration based at least in part on whether the random access message was received on the first PRACH resource set or the second PRACH resource set.

10. The method of claim 1, further comprising:
communicating, using at least one of a resource allocation, a hopping option, a timing advance, or a power control configuration based at least in part on whether the random access message was received on the first PRACH resource set or the second PRACH resource set.

11. An apparatus for wireless communication, comprising:
a processor;
memory in electronic communication with the processor; and
one or more instructions stored in the memory and operable, when executed by the processor, to cause the apparatus to:
receive, at the apparatus, an indication that a first physical random access channel (PRACH) and a second PRACH resource set are supported, wherein the first PRACH resource set is to be used by user equipments (UEs) experiencing a higher Doppler condition than UEs using the second PRACH resource set; and
transmit, by the apparatus, a random access message using one of the first PRACH resource set or the second PRACH resource set in accordance with a speed of the apparatus.

12. A method of wireless communication comprising:
differentiating between a first physical random access channel (PRACH) resource set and a second PRACH resource set, the first PRACH resource set to be used by user equipments (UEs) experiencing a higher Doppler condition than UEs using the second PRACH resource set; and
transmitting an indication that the first PRACH resource set and the second PRACH resource set are supported.

13. The method of claim 12, further comprising:
determining that the first PRACH resource set is to be used by UEs experiencing a Doppler condition that satisfies a threshold and the second PRACH resource set is to be used by UEs experiencing a Doppler condition that is less than the threshold.

14. The method of claim 12, wherein the first PRACH resource set is associated with a first cyclic shift that is detectable at a first range of speeds and the second PRACH resource set is associated with a second cyclic shift that is detectable at a second range of speeds slower than the first range of speeds.

15. The method of claim 12, wherein differentiating between the first PRACH resource set and the second PRACH resource set comprises: using a first repetition level associated with the first PRACH resource set and a second repetition level associated with the second PRACH resource set.

16. The method of claim 12, further comprising:
transmitting to a UE a PRACH association indicator indicating to the UE one or more of the first PRACH resource set or the second PRACH resource set to be used by the UE.

17. The method of claim 16, wherein the PRACH association indicator indicates that the UE is to determine, based on a Doppler condition experienced by the UE, whether to associate with the first PRACH resource set or the second PRACH resource set.

18. The method of claim 12, further comprising:
transmitting a threshold indication to a UE; and
transmitting to the UE a PRACH association indicator indicating to the UE that the UE is to determine, based on a Doppler condition experienced by the UE and the threshold indicated by the threshold indication, whether to associate with the first PRACH resource set or the second PRACH resource set.

19. The method of claim 12, further comprising:
receiving a random access message from a UE using one of the first PRACH resource set or the second PRACH resource set; and
selecting a reference signal (RS) density for at least one of physical downlink shared channel (PDSCH) or physical uplink shared channel (PUSCH) transmission based at least in part on whether the random access message was received on the first PRACH resource set or the second PRACH resource set.

20. The method of claim 12, further comprising:
receiving a random access message from a UE using one of the first PRACH resource set or the second PRACH resource; and
selecting at least one of a resource allocation, a hopping option, a timing advance, a power control, or a random access message response time based at least in part on whether the random access message was received on the first PRACH resource set or the second PRACH resource set.
